(19) United States
(12) Patent Application Publication
(10) Pub. No.: US 2025/0138162 A1
(43) Pub. Date: May 1, 2025

(54) OPTICAL SYSTEM FOR ToF AND DEPTH CAMERA OF ToF

(71) Applicant: SHENZHEN METALENX TECHNOLOGY CO.,LTD, Shenzhen (CN)

(72) Inventors: Xiaobo ZHAO, Shenzhen (CN); Heshan LIN, Shenzhen (CN); Chenglong HAO, Shenzhen (CN); Fengze TAN, Shenzhen (CN); Jian ZHU, Shenzhen (CN)

(73) Assignee: SHENZHEN METALENX TECHNOLOGY CO.,LTD, Shenzhen (CN)

(21) Appl. No.: 18/923,637

(22) Filed: Oct. 22, 2024

(30) Foreign Application Priority Data
Oct. 27, 2023 (CN) 202322894680.3

(51) Int. Cl. G01S 7/481; G01S 17/42; G01S 17/894; G02B 1/00

(52) U.S. Cl. CPC G01S 7/4816; G01S 17/42; G01S 17/894; G02B 1/002

(57) ABSTRACT

An optical system for ToF and a depth camera of ToF are provided, and the optical system including two optical elements. The two optical elements along the optical axis in order from an object side to an image side include: a filter and a metalens; each of two optical elements includes an object-side surface facing towards the object side and an image-side surface facing towards the image side; the metalens includes a substrate and a plurality of unit cells; and a plurality of nanostructures are set on a vertex and center of the unit cells of the metalens; the optical system includes an aperture slot, and the aperture slot is set on an incident direction of an optical path of the metalens; the optical system satisfies the following condition:

$$\frac{f}{D} \leq 1.2 ;$$

f is a focal length of the optical system, and D is an entrance pupil diameter of the optical system.

### CROSS-REFERENCE TO RELATED APPLICATION

This application claims the benefit of priority from Chinese Patent Application No.202322894680.3, filed on Oct. 27, 2023. The content of the aforementioned application, including any intervening amendments thereto, is incorporated herein by reference in its entirety.

### TECHNICAL FIELD

The present disclosure relates to a field of an optical lens, in particular to an optical system for ToF and a depth camera of ToF.

### BACKGROUND

ToF (Time of Flight) technology is based on the time of flight of beams to obtain 3D imaging and information of depth for the photographed environment. ToF is widely used in the fields of 3D vision, obstacle avoidance of the automatic robot, and autonomous driving. In relevant technology, the optical system used for ToF often needs to use more lenses to increase the aperture to correct the aberrations introduced by the increased aperture of the optical system, which leads to the large volume of this kind of optical system and it is not conducive to the lightweight of the ToF lens. Therefore, there is an urgent need for an optical system for ToF that has both a large aperture and a small volume while ensuring the imaging quality.

### SUMMARY

In order to solve the above technical problem, an optical system for ToF and a depth camera of ToF are provided according to the present application. The optical system provided by the present application is capable of satisfying the requirements of the optical system for large aperture and small volume at the same time.

On the one hand, an optical system is provided, the optical system including two optical elements, wherein the two optical elements along the optical axis in order from an object side to an image side include: a filter and a metalens;
each of two optical elements includes an object-side surface facing towards the object side and an image-side surface facing towards the image side;
the metalens includes a substrate and a plurality of unit cells; and a plurality of nanostructures are set on a vertex and/or center of the unit cells of the metalens;
the optical system includes an aperture slot, and the aperture slot is set on an incident direction of an optical path of the metalens;
the optical system satisfies the following condition:

$$\frac{f}{D} \leq 1.2$$

wherein, f is a focal length of the optical system, and D is an entrance pupil diameter of the optical system.

In one embodiment, the optical system satisfies the following condition:

$$\frac{f}{D} \leq 1.18$$

In one embodiment, the optical system satisfies the following condition:

$$0.7 \leq \frac{L}{f} \leq 1.2$$

wherein L is a paraxial distance between the aperture slot and the image-side surface of the metalens; f is a focal length of the optical system.

In one embodiment, the optical system satisfies the following condition:

$$0.8 \leq \frac{L}{f} \leq 1.1 .$$

In one embodiment, the optical system satisfies the following condition:

$$3.1 \leq \frac{TTL}{imgH} \leq 3.5$$

wherein TTL is a total track length of the optical system; imgH is a half of maximum image height of the optical system.

In one embodiment, the optical system satisfies the following condition:

$$3.3 \leq \frac{TTL}{imgH} \leq 3.4$$

In one embodiment, the optical system satisfies the following condition:

$$0.75 \leq \frac{{D}_{w}}{D} \leq 1$$

wherein D_{w} is a beam width of the light with a maximum incident angle of the optical system; D is an entrance pupil diameter of the optical system.

In one embodiment, the maximum incident angle is greater than or equal to 36.5°.

In one embodiment, the optical system satisfies the following condition:

$$0.81 \leq \frac{{D}_{w}}{D} < 1 .$$

On the other hand, a depth camera of ToF is provided, wherein the depth camera includes a light emitting device and a light receiving device;
the receiving device for light includes the optical system and an imaging detector; and the imaging detector is set on the image plane;
the emitting device for light is used to emit lights to a target;
the optical system is used to receive and collimate the lights reflected by the imaging detector, and the imaging detector is used to obtain the image of the target, so as to obtain data of depth of field according to the image of the target.

The optical system for ToF provided by the present application, the optical system for TOF along the optical axis in order from an object side to an image side includes: a filter and a metalens. The filter is set on the incident direction of the optical path of the metalens. In the first aspect, the filter is used to block lights outside the target waveband, so as to avoid the influence on imaging quality caused by the lights outside the target waveband. In the second aspect, the filter isn't set on the outgoing direction of the optical path of the metalens, which avoids the occupation of the filter for the back focal length of the optical system and limits the back focal space of the optical system. It is beneficial to improve the imaging quality. The metalens has a higher free degree of optical modulation than the conventional lens. Compared with the optical system with a plurality of conventional lenses in prior art, the optical system provided in this embodiment uses only one piece of metalens to correct the aberrations better, and the optical system provided in this embodiment obtains a good imaging quality. Therefore, on the premise of ensuring the imaging quality of the optical system, the number of lenses of the optical system is reduced, the TTL of the optical system is shortened, and the volume and weight of the optical system are reduced. The optical system further includes an aperture slot, and the aperture slot is set on the incident direction of the optical path of the metalens. In the first aspect, the aperture slot is set on the object side of the metalens, which is beneficial to reduce the aperture of the metalens and is beneficial to reduce the aperture of the optical system. In the second aspect, the aperture slot is set on the object side of the metalens, which is beneficial to adjust the position of the aperture slot on the focal plane of the object side of the metalens or the position of the aperture slot closed to the focal plane of the object side of the metalens, so that the optical system can be or may be a telecentric system in image space. In this way, the optical system has a higher relative illumination. In the third aspect, the aperture slot isn't set on the outgoing direction of the optical path of the metalens, which will avoid the occupation of aperture slot for the back focal space of the optical system and the limitation of the back focal space of the optical system, which is beneficial to improve the imaging quality of the optical system. The ratio of the focal length of the optical system to the entrance pupil diameter of the optical system is an F number of the optical system, and the F number of the optical system is less than or equal to 1.2. Compared with the optical system in prior art, the optical system provided by the present embodiment is an optical system with a larger aperture. And the optical system with a larger aperture has more light intake, and the imaging picture of the optical system is brighter. Although the design of the large aperture can easily produce more aberrations, the present application uses a metalens that can provide the phase required of the optical system flexibly. Thus the optical system including a metalens can correct the aberrations better and ensure the good imaging quality of the optical system. In summary, the optical system has the advantage of a shorter total track length (TTL), smaller volume and good imaging quality at the same time.

Other features and advantages of the present application will become apparent by the detailed description below, or will be acquired in part by the practice of the present application.

It should be understood that the above description is general, and the detailed description described below is exemplary only, and will not limit this application.

### BRIEF DESCRIPTION OF THE DRAWINGS

The above and other targets, features and advantages of the example embodiment thereof by reference to the accompanying drawings.

FIG. 1 shows a schematic diagram of the architectural layout of the optical system in one embodiment provided by the present application.

FIG. 2 shows a schematic diagram of the architectural layout of the optical system in one embodiment provided by the present application.

FIG. 3 shows a diagram of relative illumination of the optical system in one embodiment provided by the present application.

FIG. 4 shows a curve diagram between the MTF and the field of view of the optical system in one embodiment provided by the present application.

### DETAILED DESCRIPTION OF DISCLOSURED EMBODIMENTS

The embodiments will be described more comprehensively with reference to the accompanying drawings. However, the embodiments can be implemented in various forms and should not be understood to be limited to the examples elaborated herein; instead, providing these embodiments makes the description of this application more comprehensive and complete and fully communicates the idea of the embodiment to those skilled in the art. The attached drawings are only schematic illustrations of this application and are not necessarily proportional drawings. The same reference marks in the figure indicate the same or similar parts, and their repeated descriptions will be omitted.

Furthermore, the described features, structures or features may be combined in one or more embodiments in any suitable manner. In the following description, many specific details are provided to give a full understanding of the exemplary embodiments of this application. However, those skilled in the art will be aware that one or more of the specific details may be omitted from the present technical solution, or other modules, components, etc. may be adopted. In other cases, aspects of the present application are blurred without detailed showing or describing the public structure, method, implementation or operation to avoid over dominance.

For the optical system in prior art, the optical system with smaller volume will have less light intake, which will lead to a low signal-to-noise ratio and poor imaging quality on the imaging detector, and the optical system in prior art cannot be better to reflect the information of the depth of the objection. If the aperture is forced to be increased, the optical system will be easier to produce more aberrations, and the optical system will require more conventional lenses to correct the aberrations, which will result in an increase in the volume of the optical system. It can be seen that in the scheme provided by prior art, the optical system is difficult to guarantee both large aperture and small volume.

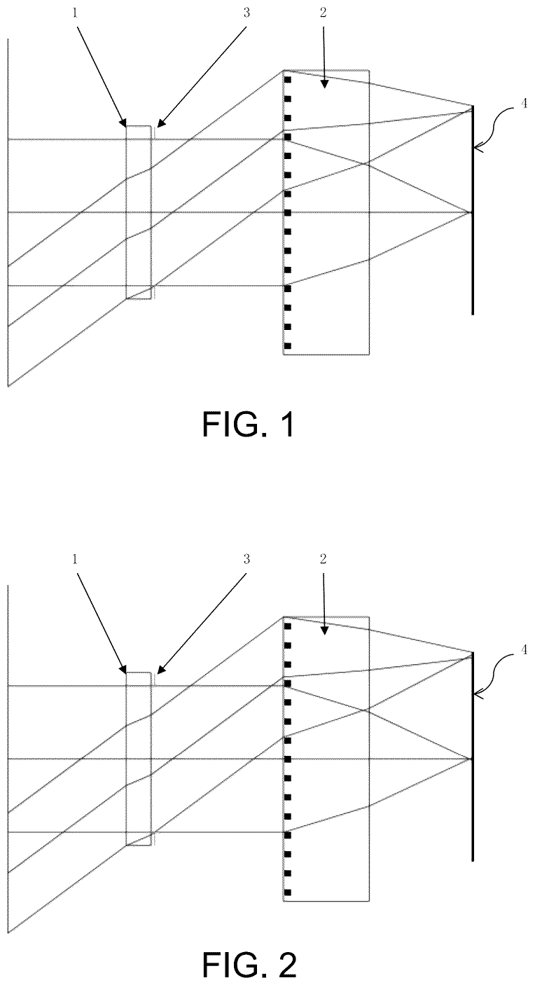

In order to overcome the above disadvantages, an optical system and a depth camera of ToF are provided by the present application. FIG. 1 shows a schematic diagram of the architectural layout of the optical system for ToF in one embodiment provided by the present application. In FIG. 1, the object plane of an optical system is on the left of FIG. 1, and the image plane of an optical system is on the right of FIG. 1. Because the position of the object plane is uncertain, the position of the object plane hasn't been shown.

As shown in FIG. 1, the optical system for ToF includes two optical elements, the two optical elements being, along the optical axis in order from an object side to an image side: a filter 1 and a metalens 2. The metalens includes a substrate and a plurality of unit cells, and a plurality of nanostructures are set in the unit cells. The vertex and/or the center of the unit cell is set with nanostructures.

The filter is set on the incident direction of the optical path of the metalens. In the first aspect, the filter is used to block lights outside the target waveband, so as to avoid the influence for imaging quality caused by the lights outside the target waveband. In the second aspect, the filter isn't set on the outgoing direction of the optical path of the metalens, which avoids the occupation of the filter for the back focal length of the optical system and limits the back focal space of the optical system. It is beneficial to improve the imaging quality.

The optical system in the present embodiment is set with metalens 2. The metalens has a higher free degree of optical modulation than the conventional lens. Compared with the optical system with a plurality of conventional lenses in prior art, the optical system provided in this embodiment uses only one piece of metalens to correct the aberrations better, and the optical system provided in this embodiment obtains a good imaging quality. Therefore, on the premise of ensuring the imaging quality of the optical system, the number of lenses of the optical system is reduced, the TTL of the optical system is shortened, and the volume and weight of the optical system are reduced.

The optical system further includes an aperture slot, and the aperture slot is set on the incident direction of the optical path of the metalens. In the first aspect, the aperture slot is set on the object side of the metalens, which is beneficial to reduce the aperture of the metalens and is beneficial to reduce the aperture of the optical system. In the second aspect, the aperture slot is set on the object side of the metalens, which is beneficial to adjust the position of the aperture slot on the focal plane of the object side of the metalens or the position of the aperture slot closed to the focal plane of the object side of the metalens, so that the optical system can be or may be a telecentric system in image space. In this way, the optical system has a higher relative illumination. In the third aspect, the aperture slot isn't set on the outgoing direction of the optical path of the metalens, which will avoid the occupation of aperture slot for the back focal space of the optical system and the limitation of the back focal space of the optical system, which is beneficial to improve the imaging quality of the optical system.

The optical system satisfies the following condition:

$$\frac{f}{D} \leq 1.2 \qquad ( 1 )$$

f is a focal length of the optical system, and D is an entrance pupil diameter of the optical system.

The ratio of the focal length of the optical system to the entrance pupil diameter of the optical system is an F number of the optical system, and the F number of the optical system is less than or equal to 1.2. Compared with the optical system in prior art, the optical system provided by the present embodiment is an optical system with a larger aperture. And the optical system with a larger aperture has more light intake, and the imaging picture of the optical system is brighter. Although the design of the large aperture can easily produce more aberrations, the present application uses a metalens that can provide the phase required of the optical system flexibly. Thus the optical system including a metalens can correct the aberrations better and ensure the good imaging quality of the optical system. In summary, the optical system has the advantage of a shorter total track length (TTL), smaller volume and good imaging quality at the same time.

In one embodiment, preferably, a ratio of the focal length of the optical system to an entrance pupil diameter satisfies:

$$\frac{f}{D} \leq 1.18 \qquad ( 2 )$$

The optical system satisfying condition (2) can satisfy the requirement of a larger aperture further, at the same time, the optical system ensures the imaging quality of the optical system.

In one embodiment, the nanostructures may be positive nanostructures or negative nanostructures. When the nanostructures are positive nanostructures, the positive nanostructures are set on the surface of the substrate. When the nanostructures are negative nanostructures, the negative nanostructures may be hollow parts set above the surface of the substrate, and the gaps between the hollow parts and the hollow parts are filled with a filler material. The filler material may be the same as the material of the substrate or be different from the material of the substrate with a high transmittance at the working waveband.

In one embodiment, the nanostructures may be set on the object-side surface of the substrate, or the nanostructures may be set on the image-side surface of the substrate and on the object-side surface of the substrate.

It should be noted that an object-side surface is a surface of the corresponding optical element facing towards the object side, and an image-side surface of the corresponding optical element is a surface facing towards the image side.

In one embodiment, an aperture slot is set between the filter and the metalens. In other words, the filter is the first optical element of the optical system. In this way, the filter is used to protect the optical system. For example, the filter may prevent the dust or dirt entering the optical system. In addition, the filter can also protect the metalens from being contaminated or scratched.

In one embodiment, the BFL (back focal length) provided by the present embodiment satisfies condition (3):

0.7mm≤BFL≤1mm (3)

In the present embodiment, the condition (3) can limit the size and imaging quality of the optical system.

Specifically, the highest value of condition (3) is configured to be 1 mm to ensure that the optical system has a sufficiently small BFL. On the one hand, the BFL is smaller, so the optical system is more compact and has a smaller TTL; on the other hand, shortening the BFL can improve the ability of the optical system to correct aberrations, which helps to improve the imaging quality. However, the BFL cannot be infinitely smaller. In order to avoid the lack of assembly space caused by too small BFL, the lowest value of condition (3) is configured to be 0.7 mm.

Preferably, to design a smaller volume and a better imaging quality of the optical system, and the BFL of the optical system satisfies following condition (4):

0.8mm≤BFL≤0.9mm (4)

In one embodiment, the aperture slot is set on the surface of the filter. In other embodiment, an air gap is set between the aperture slot and the filter, and the aperture slot and the filter are disconnected.

In one embodiment, the optical system satisfies the following condition (5)

$$0.7 \leq \frac{L}{f} \leq 1.2 \qquad ( 5 )$$

L is a paraxial distance between the aperture slot and the image-side surface of the metalens; f is a focal length of the optical system. Specifically, L and f have the same unit. (For example, L and f both have the unit of mm).

In the present embodiment, the optical system has a single lens, and the lens is metalens. Therefore, the focal length of the optical system is equal to the focal length of the metalens. When condition (5) is equal to 1, the aperture slot is set on the focal plane of the object side, and the optical system is a telecentric system in image space. In the telecentric system in image space, the chief ray of each field of view of the system is parallel to the optical axis, and the brightness of the image plane is very uniform, that is, the relative illumination is very high. When the ratio of L to f is not equal to 1, but is relatively close to 1, the optical system is approximately close to the telecentric system in image space and still has a high relative illumination. In one embodiment, the highest value of this condition (5) is configured to be 1.2 and the lowest value is configured to be 0.7 to ensure that the optical system has sufficient relative illumination.

Preferably, to improve the relative illumination of the optical system, condition (6) satisfies the following condition (6):

$$0.7 \leq \frac{L}{f} \leq 1.1 \qquad ( 6 )$$

In one embodiment, the optical system provided by the application satisfies the following condition:

$$3.1 \leq \frac{TTL}{imgH} \leq 3.5 \qquad ( 7 )$$

TTL is a total track length of the optical system, which is a distance between the object-side surface of the optical element of the optical system and the image plane. When the filter is set on the incident direction of the optical path of the aperture slot, the TTL is the distance between the object-side surface of the filter and the image plane; when the aperture slot is set on an incident direction of the optical path of the filter, the TTL is the distance between the object-side surface of the aperture slot and the image plane. imgH is a half of maximum image height of the optical system, that is, a half of the diagonal length of the effective pixel region of the electronic sensor. Specifically, TTL and imgH have the same unit. (For example, TTL and imgH both have unit of mm.)

In the present embodiment, the design specifications of the optical system are characterized by the ratio of TTL to imgH. The ratio of TTL to imgH favors the maintenance of optical system miniaturization when located in the interval of [3.1, 3.5].

Preferably, the ratio of TTL to imgH satisfies the following condition is more beneficial to maintain the optical system miniaturization.

$$3.3 \leq \frac{TTL}{imgH} \leq 3.4 \qquad ( 8 )$$

In one embodiment, the optical system satisfies the following condition:

$$0.75 \leq \frac{{D}_{w}}{D} \leq 1 \qquad ( 9 )$$

D_{w} is a beam width of the light with a maximum incident angle of the optical system; D is an entrance pupil diameter, that is, a width of a light with an incident angle of 0, or may say, a width of an incoming light parallel to the direction of the optical axis. Specifically, D_{w} is the same unit as D (For example, the units of D_{w} and D are both expressed in mm).

The phenomenon that the light that fills the pupil is partially blocked is called vignetting. Generally, the vignetting coefficient, the condition (9) of a ratio of D_{w} to D is used to describe the degree of vignetting of beams. When the vignetting coefficient is 1, there is no phenomenon of vignetting. In the present embodiment, the vignetting coefficient can be adjusted by reducing the width of the light with the maximum incident angle to intercept the partial edge lights. Since the lights at the edge of the optical system generally have the worst aberration, reducing the vignetting coefficient can effectively improve the imaging quality and reduce the size of the lens. However, the interception of edge lights will also bring some problems. For example, after the interception of edge lights, the number of lights through the edge field of view becomes less, which will inevitably lead to less energy and lower illumination in the edge region, and reduce the relative illumination of the overall optical system. In order to prevent the vignetting coefficient from being too small to cause the vignetting, and affecting the relative illumination of the optical system, the lowest value of this condition is configured to be 0.75.

Preferably, in order to better balance the aberration and relative illumination of the optical system, the optical system provided in this application meets the following conditions:

$$0.81 \leq \frac{{D}_{w}}{D} < 1 \qquad ( 10 )$$

Further, it is difficult to correct the aberration at larger FOV fully by one metalens. Thus, it is necessary to improve the imaging quality of the larger FOV, for example, by reducing the beam width of the incoming beam of the larger FOV to intercept the beam of the larger FOV. In one embodiment, the maximum FOV is greater than or equal to 73°. Since the maximum incidence angle is equal to half of the maximum FOV, the maximum incident angle is greater than or equal to 36.5°. The optical system can correct the aberration of the incoming light in a larger FOV better by setting the incident angle greater than or equal to 36.5°, thus the optical system will have excellent imaging quality.

As mentioned above, controlling the ratio of Dw to D can control the aberration within a certain range better, but it sacrifices the relative illumination of the optical system slightly. However, the optical system is the telecentric system in image space that allows the optical system to have high relative illumination by controlling the ratio of L to f within a certain range, that is, adjusting the position relationship between the aperture slot and the metalens may compensate for the sacrificed relative illumination in the vignetting. In one embodiment, the optical system provided in the present application simultaneously satisfies the following two conditions:

$$0.7 \leq \frac{L}{f} \leq 1.2$$

$$0.75 \leq \frac{{D}_{w}}{D} < 1$$

The aberration of the optical system satisfying the above two conditions can be well corrected, and at the same time, it can maintain a very high relative illumination, thus significantly improve the imaging quality of the optical system.

In one embodiment, the working waveband of the optical system is a near-fared waveband.

In one embodiment, the optical system is applied to near-fared waveband, for example, is applied to near-infrared narrowband, for example, the optical system works at a near-infrared narrowband of [λ(100%−Δ%) [symbol] λ(100%+Δ%)], and Δ≤20. λ is a working waveband of the optical system, and λ is greater than or equal to 830 nm and is less than and equal to 1050 nm; Δ is a changeable natural number. The range of [λ(100%−Δ%) [symbol] λ(100%+Δ%)] will change with the changes of Δ. Preferably, Δ≤10.

A depth camera of ToF is provided by the application, and the depth camera of ToF includes a light emitting device and a light receiving device;
the receiving device for light comprises the optical system claimed as claim 1 and an imaging detector; and the imaging detector is set on the image plane;
the emitting device for light is used to emit lights to a target;
the optical system is used to receive and collimate the lights reflected by the imaging detector, and the imaging detector is used to obtain the image of the target, so as to obtain data of depth of field according to the image of the target.

The above depth camera for ToF uses the emitting device to emit the lights to the target and the optical system as described above to receive and collimate the lights reflected by the target, and the collimated lights are received by the imaging detector. In this way, the optical system can obtain bright, clear target depth images, which is favourable to measure the data of depth of field to perform blur in different degrees on the target image and improve the shooting effect of the depth camera for ToF.

TABLE 1
Target requirements for the various system
parameters of the optical system

| System parameter | Data |
|---|---|
| TTL | <3 mm |
| Fov | ≥73° |
| Relative illumination | ≥80% |
| F number | <1.2 |
| MTF@ 141 p/mm | ≥0.7 |

Table 1 shows the target requirements for the various system parameters of the optical system. The TTL (total track length) of the optical system is less than or equal to 3 mm; FOV (field of view) of the optical system is greater than or equal to 73°; the target requirement of the relative illumination at central wavelength is greater than or equal to 80%; F number is less than or equal to 1.2. And the target requirement of MTF (modulation transfer function) at the cut-off frequency of 14 lp/mm at all FOV is greater than 0.7. And MTF is an important indicator used to describe the image quality of the optical system. The closer the value of MTF is to the diffraction limit, the better the image quality.

With the target requirements shown in Table 1, the present application provides five embodiments with five optical systems that meet the target requirements shown in Table 1. Next, the five optical systems provided in this application are described in detail.

### Embodiment

FIG. 2 shows a schematic diagram of the architectural layout of the optical system and the depth camera for ToF in one embodiment provided by the present application. As shown in FIG. 2, in embodiment 1, the optical system for ToF including 2 optical elements is provided, and the 2 optical elements along the optical axis in order from an object side to an image side include: a filter and a metalens. And the nanostructures are set on the object-side surface of the metalens.

TABLE 2
The various system parameters of the optical system

| System Parameters | Data |
|---|---|
| TTL | 2.93 mm |
| FOV(2ω) | 73° |
| F number | 1.18 |
| Effective focal length | 1.36 mm |
| Working waveband | 850 nm |

As can be seen from Table 2, the optical system provided by the present application works at the near-infrared waveband. However, the optical system in the present embodiment doesn't represent this application can only work at a wavelength of 850 nm. The optical system has a TTL of 2.93 mm, and the TTL is less than that in the target requirement of 3 mm, which can fully satisfy the requirement of miniaturization. The F number of the optical system is 1.18, which can fully satisfy the requirements of the optical system for light intake.

Along the direction from the object side to the image side, each surface of the optical system is numbered. After summarizing the parameters of each surface, Table 3 is obtained as shown below.

TABLE 3
parameters of each surface of the optical system in embodiment

| | | | | | Refractive | Abbe |
|---|---|---|---|---|---|---|
| Surface | Name of | Type of | Curvature | | index of | number of |
| number | surfaces | surface | radius | Thickness(mm) | material | material |
| 1 | Object | — | Infinite | Infinite | — | — |
| | plane | | | | | |
| 2 | Filter | Spherical | Infinite | 0.21 | 1.5168 | 64.199 |
| | | surface | | | | |
| 3 | | Spherical | Infinite | 0.03 | — | — |
| | | surface | | | | |
| 4 | Aperture | Spherical | Infinite | 1.09 | — | — |
| | slot | surface | | | | |
| 5 | Metalens | Structural | Infinite | 0.725 | 1.4585 | 67.821 |
| | | surface | | | | |
| 6 | | Spherical | Infinite | 0.87 | — | — |
| | | surface | | | | |
| 7 | Image | — | Infinite | — | — | — |
| | plane | | | | | |

As shown in Table 3, the surface 1 is an object plane of the optical system provided by the optical system in the present application. And surface 2 is an object-side surface of the filter. The surface 3 is an image-side surface of the filter. The surface 4 is an aperture slot. The surface 5 is the object-side surface of the metalens. Because the nanostructures are set on the object-side surface of the metalens, the object-side of the metalens is recorded as a structural surface. The surface 6 is an image-side surface of the metalens. The surface 7 is the image plane of the optical system.

It can be seen from Table 3 that the curvature radius of surfaces from 1 to 7 is infinite (namely, surfaces from 1 to 7 all are planes), and the paraxial distance between the surface 1 and surface 2 is uncertain. The paraxial distance between the surface 2 and the surface 3 is 0.21 mm, that is, the thickness of the filter is 0.21 mm. The paraxial distance between the surface 3 and surface 4 is 0.03 mm, and the paraxial distance between the surface 4 and surface 5 is 1.09 mm. The paraxial distance between the surface 5 and surface 6 is 0.725 mm, namely, the thickness of the metalens is 0.725 mm. And the paraxial distance between the surface 6 and surface 7 is 0.87mm. And the refractive index of the material filled between the surface 2 and the surface 3 is 1.5168, that is, the filter is made of a material with a refractive index of 1.5168. And the refractive index of the material filled between the surface 5 and the surface 6 is 1.4585, that is, the metalens is made of a material with a refractive index of 1.4585. Air is filled between the surfaces of 1, 3, 4, 6 and its next surface, for example, air is filled between the surface 4 and surface 5, that is, an air gap is set between the aperture slot and the metalens. Similarly, in the description of the refractive index, the Abbe number will not be repeated here.

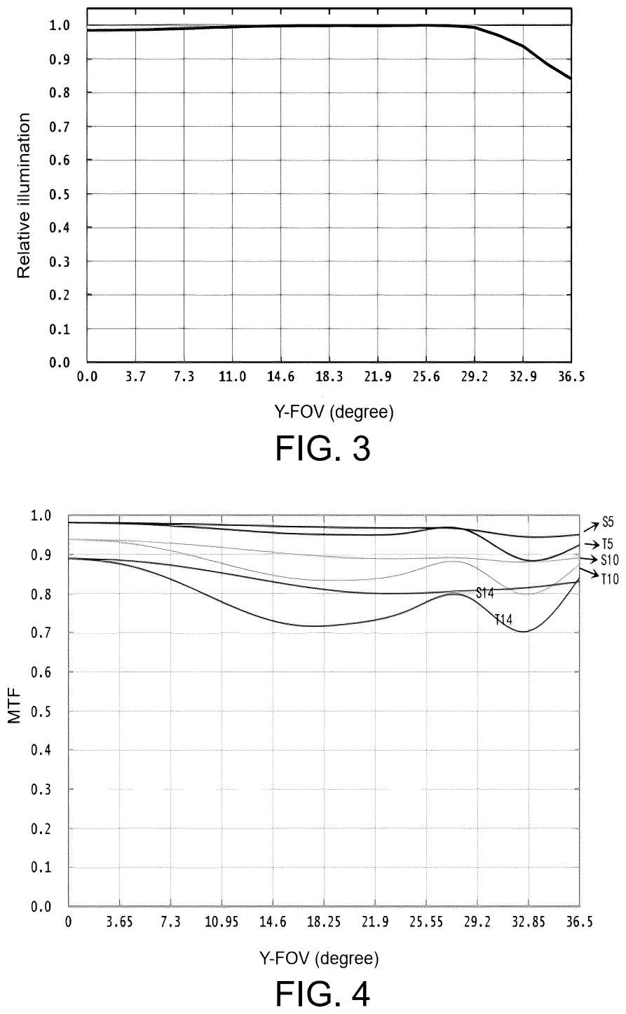

FIG. 3 shows a relative illumination of the optical system provided by the embodiment of the present application. The horizontal axis of FIG. 3 represents the FOV in the direction of Y axis (Y-FOV), and the Y-FOV is expressed in a unit of degree. The vertical axis of FIG. 3 represents the relative illumination with no unit. FIG. 3 shows a curve of relative illumination of the optical system at the wavelength of 850 nm.

As shown in FIG. 3, the relative illumination of the optical system provided by the embodiment at the FOV from 29.2° to 36.5° has decreased a little bit, but at all fields of view, the relative illumination of the optical system is always greater than 80%, which meets the target requirement of relative illumination of the optical system.

FIG. 4 shows a curve diagram between the MTF and the FOV. The horizontal axis of FIG. 4 represents the FOV in the direction of Y axis (Y-FOV), and the Y-FOV is expressed in a unit of degree. The vertical axis of FIG. 4 represents the value of MTF. In FIG. 4, T represents the meridional direction curve and S represents the sagittal direction curve. The meridional curve T5 and sagittal curve S5 correspond to the cut-off frequency of 5 lp/mm; the meridional curve T10 and sagittal curve S10 correspond to the cut-off frequency of 10 lp/mm; the meridional curve T14 and sagittal curve S14 correspond to the cut-off frequency of 14 lp/mm.

As can be seen from FIG. 4, the MTF at all fields of view at the cut-off frequency of 14 lp/mm is greater than 0.7 all the time, which indicates that the optical system provided in this embodiment has an excellent imaging quality at all fields of view.

After summarizing the lens parameters of the optical system provided by the above embodiment, Table 4 is shown below. The displays in Table 4 mainly are used to explain the conditions met by the optical system provided in this application, and are experimentally verified and supported.

TABLE 4
The lens parameters of the optical system provided by the present
embodiments

| Conditions | Embodiment | |
|---|---|---|
| L | 1.09 | mm |
| f | 1.36 | mm |
| TTL | 2.93 | mm |
| imgH | 0.87 | mm |
| D | 1.24 | mm |
| D_{w} | 1.01 | mm |

| | |
|---|---|
| $\frac{L}{f}$ | 0.80 |
| $\frac{TTL}{imgH}$ | 3.37 |
| $\frac{f}{D}$ | 1.10 |
| $\frac{{D}_{w}}{D}$ | 0.81 |

The above is only a specific embodiment of the embodiments of this disclosure, but the scope of protection of the embodiment of this disclosure is not limited to this. And those skilled in the field can easily think of any change or substitution for this disclosure, which should be covered within the protection scope of this disclosure. Therefore, the scope of the protection of the present disclosure shall be the scope of the claims.

What is claimed is:

1. An optical system for ToF, the optical system comprising two optical elements, wherein the two optical elements along the optical axis in order from an object side to an image side comprise: a filter and a metalens;
each of two optical elements comprises an object-side surface facing towards the object side and an image-side surface facing towards the image side;
the metalens comprises a substrate and a plurality of unit cells; and a plurality of nanostructures are set on a vertex or center of the unit cells of the metalens;
the optical system comprises an aperture slot, and the aperture slot is set on an incident direction of an optical path of the metalens;
the optical system satisfies the following condition:
$$\frac{f}{D} \leq 1.2$$
wherein, f is a focal length of the optical system, and D is an entrance pupil diameter of the optical system.

2. The optical system according to claim 1, wherein the optical system satisfies the following condition:
$$\frac{f}{D} \leq 1.18 .$$

3. The optical system according to claim 1, wherein the optical system satisfies the following condition:
$$0.7 \leq \frac{L}{f} \leq 1.2$$
wherein L is a paraxial distance between the aperture slot and the image-side surface of the metalens; f is a focal length of the optical system.

4. The optical system according to claim 3, wherein the optical system satisfies the following condition:
$$0.8 \leq \frac{L}{f} \leq 1.1 .$$

5. The optical system according to claim 1, wherein the optical system satisfies the following condition:
$$3.1 \leq \frac{TTL}{imgH} \leq 3.5$$
wherein TTL is a total track length of the optical system; imgH is a half of maximum image height of the optical system.

6. The optical system according to claim 5, wherein the optical system satisfies the following condition:
$$3.3 \leq \frac{TTL}{imgH} \leq 3.4 .$$

7. The optical system according to claim 1, wherein the optical system satisfies the following condition:
$$0.75 \leq \frac{{D}_{w}}{D} \leq 1$$
wherein D_{w} is a beam width of the light with a maximum incident angle of the optical system; D is an entrance pupil diameter of the optical system.

8. The optical system according to claim 7, wherein the maximum incident angle is greater than or equal to 36.5°.

9. The optical system according to claim 7, wherein the optical system satisfies the following condition:
$$0.81 \leq \frac{{D}_{w}}{D} < 1 .$$

10. The optical system according to claim 1, wherein the optical system satisfies the following condition:
0.7mm≤BFL≤1mm
wherein BFL is a back focal length of the optical system.

11. The optical system according to claim 10, wherein the optical system satisfies the following condition:
0.8mm≤BFL≤0.9mm.

12. The optical system according to claim 1, wherein the optical system works at a near-infrared waveband.

13. The optical system according to claim 1, wherein a total track length of the optical system is less than 3 mm.

14. The optical system according to claim 1, wherein a FOV of the optical system is greater than or equal to 73°.

15. The optical system according to claim 12, wherein the optical system works at a near-infrared narrowband.

16. The optical system according to claim 1, wherein a paraxial distance between the aperture slot and a nanostructure surface of the metalens is less than 1.5 mm;
and the nanostructure surface of the metalens is a surface of the metalens that has the plurality of nanostructures.

17. The optical system according to claim 1, wherein a focal length of the optical system is less than 1.5 mm.

18. The optical system according to claim 1, wherein an entrance pupil diameter of the optical system is less than 1.3 mm.

19. A depth camera of ToF, wherein the depth camera comprises a light emitting device and a light receiving device;
the receiving device for light comprises the optical system claimed as claim 1 and an imaging detector; and the imaging detector is set on the image plane;
the emitting device for light is used to emit lights to a target;
the optical system is used to receive and collimate the lights reflected by the imaging detector, and the imaging detector is used to obtain the image of the target, so as to obtain data of depth of field according to the image of the target.
